(19) United States
(12) Patent Application Publication
(10) Pub. No.: US 2019/0295768 A1
(43) Pub. Date: Sep. 26, 2019

(54) MULTISTAGE STRUCTURE ELECTROMAGNETIC DEVICE

(71) Applicant: FANUC CORPORATION, Yamanashi (JP)

(72) Inventor: Shouhei Kobayashi, Yamanashi (JP)

(73) Assignee: FANUC CORPORATION, Yamanashi (JP)

(21) Appl. No.: 16/356,064

(22) Filed: Mar. 18, 2019

(30) Foreign Application Priority Data
Mar. 20, 2018 (JP) 2018-052727

(51) Int. Cl. H01F 27/38; H01F 27/34; H01F 27/245; H01F 27/26; H01F 27/30

(52) U.S. Cl. CPC H01F 27/38; H01F 27/346; H01F 27/306; H01F 27/263; H01F 27/245

(57) ABSTRACT

A multistage structure electromagnetic device that includes a plurality of electromagnetic components stacked in multiple stages is provided. Each of the electromagnetic components includes: an outer circumferential iron core; at least three leg iron cores disposed at intervals in a circumferential direction on an inner surface side of the outer circumferential iron core; and coils respectively wound around the at least three leg iron cores, wherein each of the at least three leg iron cores is disposed to be magnetically connected to the outer circumferential iron core at one end in a direction of a winding axis line of the coil, and the other end is disposed to be magnetically connected to the other end of another leg iron core; and the coils of the electromagnetic component in one stage and the coils of the electromagnetic component in another stage are respectively connected in series.

### BACKGROUND OF THE INVENTION

### 1. Field of the Invention

The present invention relates to electromagnetic devices, for example, three-phase transformers, single-phase transformers, etc.

### 2. Description of the Related Art

In the related art, a transformer including a U-shaped or E-shaped iron core and a coil wound around the iron core is used. Since, in such a transformer, the coil is exposed to the outside of the transformer, flux may leak from the coil. The flux leakage may cause eddy currents in a metal part near the coil, which may cause a metal part of the transformer to generate heat. Generally, such flux leakage can be suppressed by disposing a shield plate near the coil (e.g., see in JP 05-52650 B).

Further, in the transformer, it is desired that the installation area can be reduced. Regarding the reduction of the installation area for a multiple transformer using a tripod iron core, JP 09-120919 A describes that “as described above, a tripod iron core in which both ends of both side legs and a center leg thereof are joined by respective end yokes is disposed such that the longitudinal direction of the both side legs is directed in a vertical direction, and windings are wound around the both side legs. Intermediate yokes that join the both side legs and the center leg are disposed between the windings. One tripod iron core is provided for each phase and windings of each phase are wound around each of the tripod iron cores. In this case, for example, three tripod iron cores are sufficient in the case of three phases. As a result, as compared with the device according to the related arts illustrated in FIG. 5, the installation area is greatly reduced and the difficulty in securing the ground is eliminated. In the case of a six-multiple transformer, the installation area is halved.” (see paragraph 0021)

### SUMMARY OF THE INVENTION

In an electromagnetic device such as a transformer etc., it is desired that flux leakage from a coil can be suppressed and an installation area can be reduced.

One aspect of the disclosure is a multistage structure electromagnetic device that includes a plurality of electromagnetic components stacked in multiple stages, wherein each of the plurality of electromagnetic components includes: an outer circumferential iron core; at least three leg iron cores disposed at intervals in a circumferential direction on an inner surface side of the outer circumferential iron core; and coils respectively wound around the at least three leg iron cores, wherein each of the at least three leg iron cores is disposed such that one end in a direction of a winding axis line of the coil, of the each of the at least three leg iron cores, is magnetically connected to the outer circumferential iron core, and the other end in the direction of the winding axis line is magnetically connected to the other end of another leg iron core among the at least three leg iron cores; and the coils wound around the at least three leg iron cores of an electromagnetic component in one stage among the plurality of electromagnetic components stacked in the multiple stages and the coils wound around the at least three leg iron cores of the electromagnetic component in another stage among the plurality of electromagnetic components stacked in the multiple stages are respectively connected in series.

### BRIEF DESCRIPTION OF THE DRAWINGS

The objects, features and advantages of the present invention will become more apparent from the following description of the embodiments in connection with the accompanying drawings, wherein:

FIG. 1A is a perspective view of a multistage structure multiphase transformer according to first embodiment,

FIG. 1B is a plan view of the multistage structure multiphase transformer in FIG. 1A when viewed from above,

FIG. 2 is a schematic diagram illustrating electromagnetic connection between a primary side and a secondary side in coils that overlap vertically of the multistage structure multiphase transformer in FIG. 1A,

FIG. 3A is a perspective view illustrating a state in which the multistage structure multiphase transformer in FIG. 1A is mounted on a housing frame,

FIG. 3B is a side view illustrating the state in which the multistage structure multiphase transformer in FIG. 1A is mounted on the housing frame,

FIG. 4 is a diagram illustrating a use example of the multistage structure multiphase transformer as a three-phase transformer in FIG. 1A,

FIG. 5 is a cross-sectional view of a multiphase transformer constituting one layer of a multistage structure multiphase transformer according to a second embodiment when cut along a plane parallel to a horizontal direction,

FIG. 6 is a cross-sectional view of a multiphase transformer constituting one layer of a multistage structure multiphase transformer according to a third embodiment when cut along a plane parallel to a horizontal direction,

FIG. 7A is a perspective view of a multiphase transformer of one stage configuration as comparative example,

FIG. 7B is a plan view of the multiphase transformer in FIG. 7A when viewed from above,

FIG. 8 is a schematic diagram illustrating electromagnetic connection between a primary side and a secondary side of each phase in coils of the multiphase transformer in FIG. 7A.

### DETAILED DESCRIPTION

Embodiments of the present invention will be described below with reference to the accompanying drawings. Throughout the drawings, corresponding components are denoted by common reference numerals. To make it easy to understand, scales of these drawings are appropriately changed. Note that modes illustrated in the drawings are merely examples to implement the invention, and the invention is not limited to the modes illustrated. The electromagnetic device according to the embodiment of the present invention is, for example, a transformer, a reactor, etc.

### First Embodiment

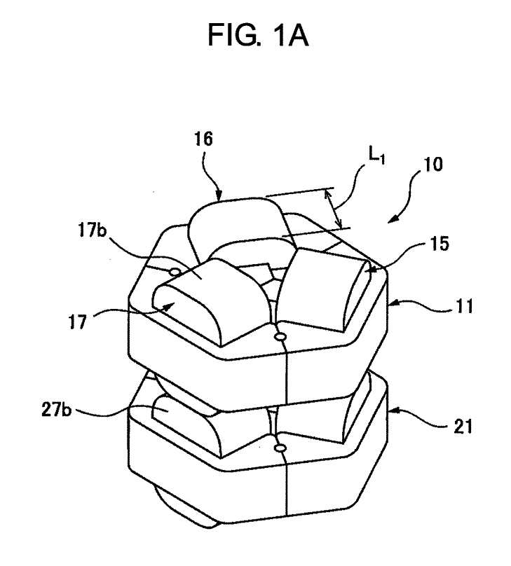

FIG. 1A is a perspective view of a multistage structure electromagnetic device 10 according to a first embodiment, and FIG. 1B is a plan view of the multistage structure electromagnetic device 10 when viewed from above. Note that, since the multistage structure electromagnetic device 10 is used as a multiphase transformer (specifically, a three-phase transformer), the multistage structure electromagnetic device 10 will be referred to as a multistage structure multiphase transformer 10 hereinafter. As illustrated in FIG. 1A and FIG. 1B, the multistage structure multiphase transformer 10 has a structure in which two multiphase transformers (electromagnetic components) 11 and 21 are overlapping vertically in two stages. The multiphase transformers 11 and 21 have the same structure. Hereinafter, the structure of the multiphase transformer 11 will be described in detail, but the description also applies to the multiphase transformer 21.

As illustrated in FIG. 1A and FIG. 1B, the multiphase transformer 11 includes an outer circumferential iron core 19 having a hexagonal outer shape in a plan view, and three iron core coils 15 to 17 disposed inside the outer circumferential iron core 19. The three iron core coils 15 to 17 include iron cores (leg iron core) 15a to 17a and coils 15b to 17b wound around the iron cores 15a to 17a, respectively. Each of the coils 15b to 17b may include both a primary coil and a secondary coil. The iron cores 15a to 17a may be formed integrally with the outer circumferential iron core 19; or may be formed separately from the outer circumferential iron core 19 and may be configured to be in contact with or magnetically connected to the outer circumferential iron core 19.

The three iron core coils 15 to 17 have the same size and shape and are disposed at equal intervals in a circumferential direction around the central part P of the outer circumferential iron core 19 on an inner side of the outer circumferential iron core 19. Tip parts on the side of the central part P of the iron cores 15a to 17a of the iron core coils 15 to 17 are closely contacted to each other. In this case, among central axis lines (winding axis lines) l₀ of the three iron core coils 15 to 17, two of the central axis lines l₀ that are adjoining intersect at the central part P so as to form an angle of 120 degrees. Further, each of the tip parts of the iron cores 15a to 17a extending along the central axis lines l₀ of the three iron core coils 15 to 17 has a shape converging toward the central part P, and the tip part forms an angle of about 120 degrees. The three iron core coils 15 to 17 are surrounded by the outer circumferential iron core 19 in this way; thus, the flux leakage from each of the coils 15b to 17b to the outside of the outer circumferential iron core 19 can be suppressed. Therefore, the necessity of disposing a shield plate to the outside of the multiphase transformer 10 can be eliminated, and the cost can be reduced. Further, when the multiphase transformer 10 having the above-described configuration is used as a three-phase transformer, an advantage that the magnetic path lengths of three phases become structurally equal is obtained.

Note that, as illustrated in FIG. 1A and FIG. 1B, the iron cores constituting each of the multiphase transformers 11 and 21 may be configured by three iron core parts 9 having the same size and shape. By dividing the iron core of each of the multiphase transformers 11 and 21 into three parts, the multistage structure multiphase transformer 10 can be efficiently assembled. Each of the iron core parts 9 is formed by stacking a plurality of iron sheets, carbon steel sheets, and electromagnetic steel sheets, for example.

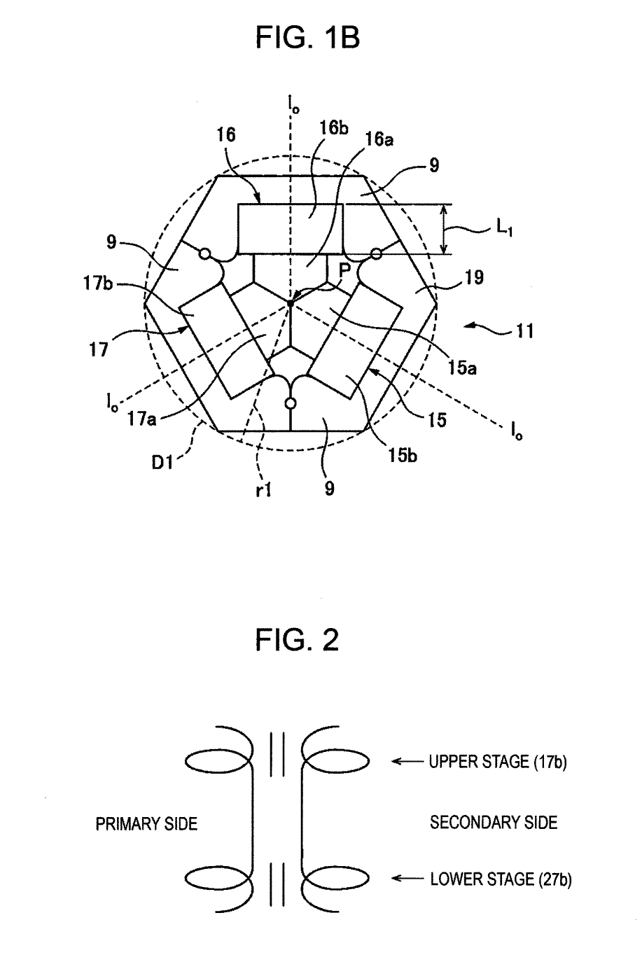

In the multistage structure multiphase transformer 10 according to the present embodiment, two coils (e.g., the coil 17b and the coil 27b illustrated in FIG. 1A) that overlap vertically in a state where the multiphase transformers 11 and 21 overlap each other are connected in series, i.e., a coil of one phase is formed by connecting, in series, the coils that overlap vertically. Note that, in a case where each of the coils 17b and 27b has a primary winding and a secondary winding, the primary winding in the coil 17b and the primary winding in the coil 27b are connected in series, and the secondary winding in the coil 17b and the secondary winding in the coil 27b are connected in series. By making wire connection in this way, as illustrated in FIG. 2 as a schematic diagram, a total winding number of the winding number of the primary winding in the upper stage coil (17b) and the winding number of the primary winding in the lower stage coil (27b) is secured as the coil of the primary side, and further, a total winding number of the winding number of the secondary winding in the upper stage coil (17b) and the winding number of the secondary winding in the lower stage coil (27b) is secured as the coil of the secondary side, and in this state the primary side and the secondary side can be electromagnetically connected, i.e., in the multistage structure multiphase transformer 10 according to the present embodiment, the winding number of each phase can be the sum of the winding number of the coils that overlap vertically.

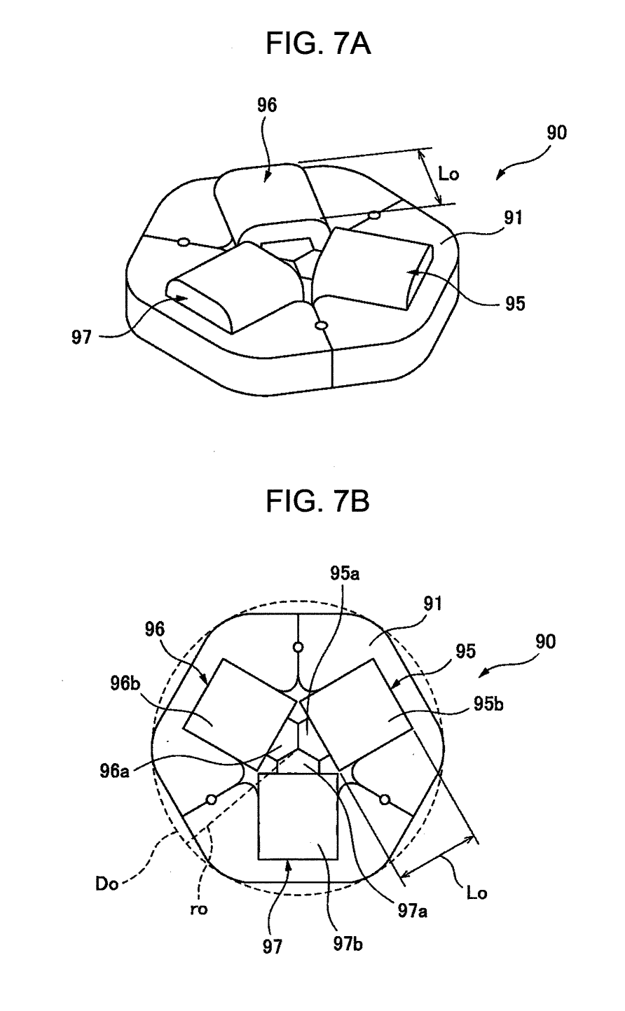

The multistage structure multiphase transformer 10 according to the present embodiment has an advantage that the installation area can be reduced by overlapping two of the multiphase transformers 11 and 21 vertically in two stages (i.e., the two multiphase transformers 11 and 21 are stacked to overlap each other when viewed along a direction perpendicular to a plane including each of the winding axis lines l₀ of the coils 15b to 17b). To describe the advantage in terms of reducing the installation area of the multistage structure multiphase transformer 10, let us make a comparison with a multiphase transformer of single-stage structure illustrated, as a comparative example, in FIG. 7A and FIG. 7B. FIG. 7A is a perspective view of a multiphase transformer 90 having a single-stage structure as a comparative example, and FIG. 7B is a plan view of the multiphase transformer 90 when viewed from above. The multiphase transformer 90 is similar in general structure to the multiphase transformer 11 of FIG. 1A, except for the size of each part and overall size, i.e., the multiphase transformer 90 includes an outer circumferential iron core 91 having a hexagonal outer shape in the plan view of FIG. 7B, and three iron core coils 95 to 97 disposed inside the outer circumferential iron core 91. The three iron core coils 95 to 97 have the same size and shape and are disposed at equal intervals in the circumferential direction around the center of the outer circumferential iron core 91 in the plan view of FIG. 7B. The three iron core coils 95 to 97 have iron cores 95a to 97a and coils 95b to 97b wound around the iron cores 95a to 97a, respectively. Each of the coils 95b to 97b may include both a primary coil and a secondary coil. The three iron core coils 95 to 97 are disposed to be inside the outer circumferential iron core 91 and to be surrounded by the outer circumferential iron core 91.

Let us consider a case where each phase of the multistage structure multiphase transformer 10 according to the present embodiment and each phase of the multiphase transformer 90 of the comparative example have the same winding number, and the multistage structure multiphase transformer 10 and the multiphase transformer 90 have the same performance as a three-phase transformer. In this case, in the multistage structure multiphase transformer 10 according to the present embodiment, the coils of the respective phases have the upper and lower two-stage configuration; thus, a coil length L₁ can be reduced to approximately ½ as compared with a coil length L₀ of the multiphase transformer 90 (see FIGS. 1A and 1B, FIG. 7A and FIG. 7B). Therefore, the ground contact area defined by the hexagonal outer shape of the multistage structure multiphase transformer 10 when viewed from above can be reduced by an amount corresponding to the reduction in the coil length, as compared with the ground contact area defined by the hexagonal outer shape of the multiphase transformer 90 of the comparative example when viewed from above. In another expression, a radius r₁ of a circumscribed circle Di of the hexagonal outer shape of the multistage structure multiphase transformer 10 in the plan view of FIG. 1B can be reduced by an amount corresponding to the reduction in the coil length, as compared with a radius ro of a circumscribed circle Do of the hexagonal outer shape of the multiphase transformer 90 of the comparative example in the plan view of FIG. 7B.

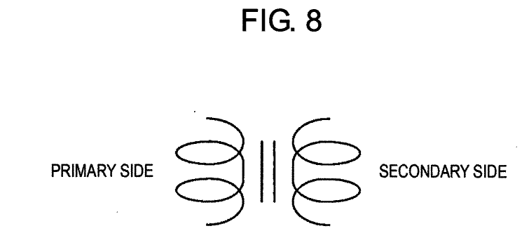

FIG. 8 is a schematic diagram illustrating electromagnetic connection between a primary side and a secondary side of each phase in the multiphase transformer 90. By comparing FIG. 2 with FIG. 8, the state of the electromagnetic connection between the primary side and the secondary side in each phase of the multistage structure multiphase transformer 10 according to the present embodiment can be understood more clearly.

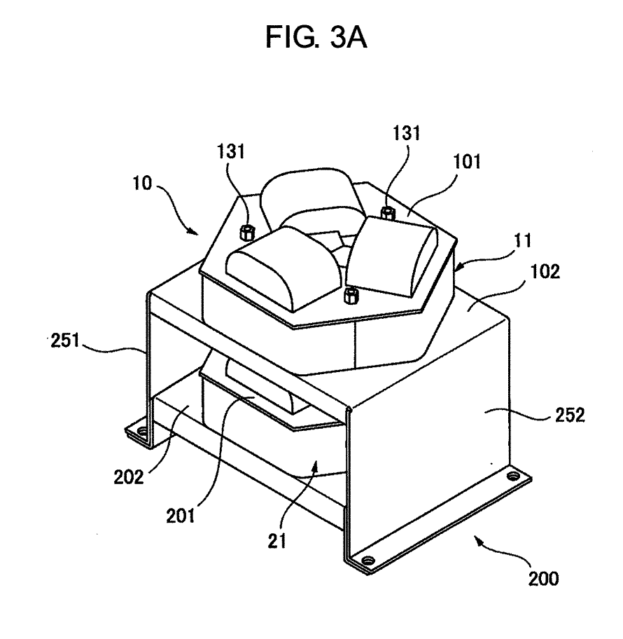

Next, an example of an assembling structure for assembling the multistage structure multiphase transformer 10 according to the present embodiment into one product will be described with reference to FIG. 3A and FIG. 3B. FIG. 3A is a perspective view illustrating a state in which the multistage structure multiphase transformer 10 is mounted on a housing frame 200, and FIG. 3B is a side view illustrating the state in which the multistage structure multiphase transformer 10 is mounted on the housing frame 200. In order to mount the multistage structure multiphase transformer 10 on the housing frame 200, as illustrated in FIG. 3A and FIG. 3B, an upper stage multiphase transformer 11 is fixed by bolts 131 in a state of being sandwiched between a first upper plate 101 and a first lower plate 102. Further, a lower stage multiphase transformer 21 is fixed by the bolts 131 in a state of being sandwiched between a second upper plate 201 and a second lower plate 202.

A side surface on the upper left side in FIG. 3A and a side surface on the lower right side in FIG. 3A of the first lower plate 102 are formed to extend downward and constitute a pair of side wall surfaces 251 and 252. A side surface on upper left side and a side surface on the lower right side of the second lower plate 202 in FIG. 3A are respectively fixed to the pair of side wall surfaces 251 and 252, in a state in which a gap is formed between the lower surface of each coil of the upper stage multiphase transformer 11 and the upper surface of each coil of the lower stage multiphase transformer 21 as illustrated in FIG. 3B. As described above, the multistage structure multiphase transformer 10 is mounted on the fixed frame 200.

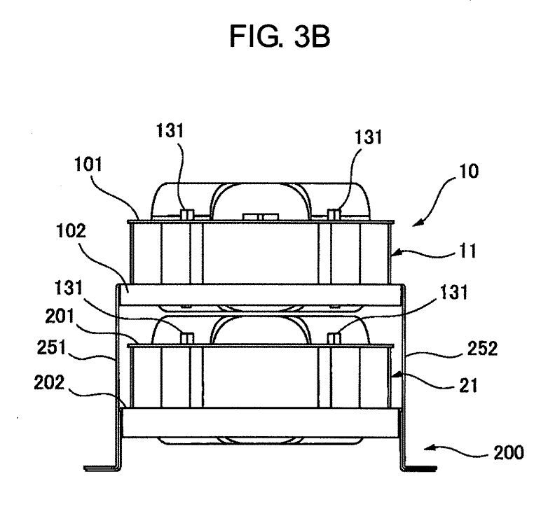

FIG. 4 is a diagram illustrating a use example of the multistage structure multiphase transformer 10 as a three-phase transformer. As illustrated in FIG. 4, the multistage structure multiphase transformer 10 may be disposed on a downstream side of a three-phase AC power source PS.

In the present embodiment, the upper stage multiphase transformer 11 and lower stage multiphase transformer 21 have the same size and shape. By thus stacking the multiphase transformers having the same size and shape in multiple stages, the magnetic fluxes of the upper and lower multiphase transformers can be prevented from being unbalanced. However, the configuration of the present invention is not limited to such an example.

### Second Embodiment

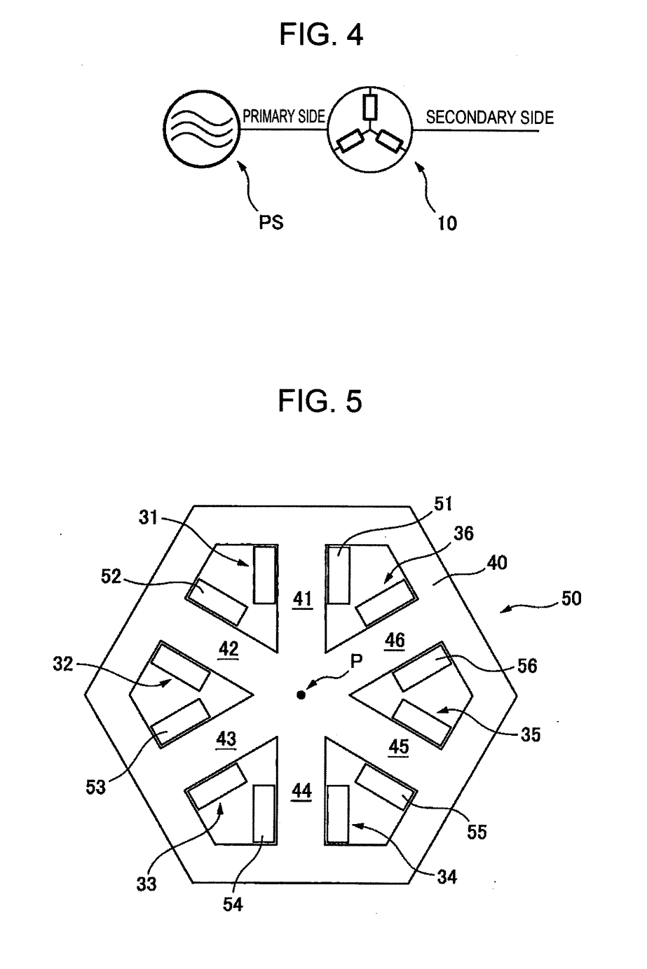

In the first embodiment described above, the multiphase transformer (11, 21) of each layer is configured to include three iron core coils inside the outer circumferential iron core, but the number of iron core coils disposed inside the outer circumferential iron core is not limited to the above-described example of the first embodiment. FIG. 5 shows a configuration example in which the multiphase transformer of each layer constituting the multistage structure multiphase transformer includes six iron core coils. FIG. 5 is a cross-sectional view obtained by cutting a multiphase transformer 50 constituting one layer of the multistage structure multiphase transformer along a plane parallel to the horizontal direction. The multiphase transformer 50 illustrated in FIG. 5 includes an outer circumferential iron core 40 having a hexagonal outer shape in a plan view, and six iron core coils 31 to 36 disposed inside the outer circumferential iron core 40. The six iron core coils 31 to 36 include iron cores (leg iron core) 41 to 46 and coils 51 to 56 wound around the iron cores 41 to 46, respectively. The six iron core coils 31 to 36 have the same shape and size and are disposed at equal intervals in a circumferential direction around a central part P of the outer circumferential iron core 40 and inside the outer circumferential iron core 40.

When the multiphase transformer 50 is thus configured to have iron core coils of a multiple of three, the multiphase transformer 50 can be used as a three-phase transformer. In this case, each of the coils can be connected in series or in parallel. The multistage structure multiphase transformer of the second embodiment is configured by vertically overlapping the multiphase transformers 50 in two or more stages as in the case of the first embodiment. As in the case of the first embodiment, the coils that overlap vertically are connected in series. Even when the multiphase transformer 50 of each layer has the configuration of FIG. 5, the same effect as that of the multistage structure multiphase transformer 10 illustrated in FIG. 1A and FIG. 1B can be obtained in terms of the ground contact area.

### Third Embodiment

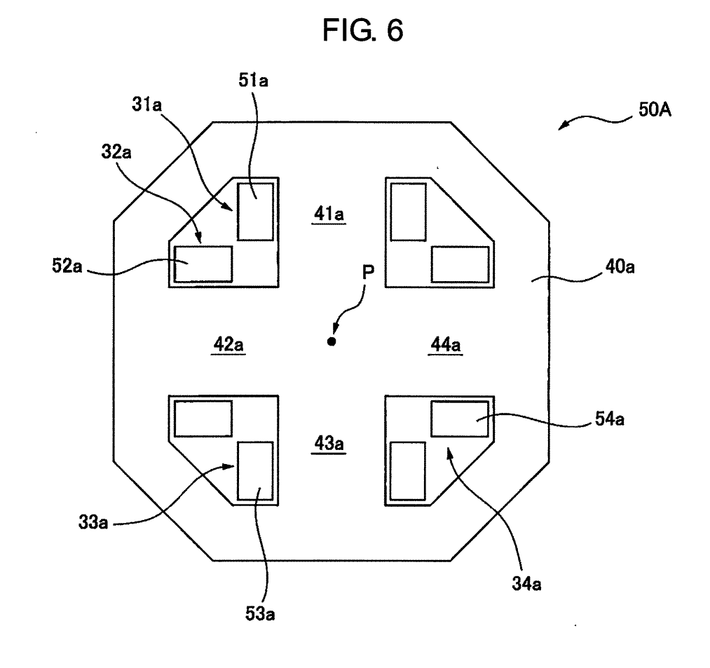

In the first embodiment described above, the transformer (11, 21) of each layer in the multistage structure electromagnetic device is configured to include three iron core coils inside the outer circumferential iron core, but the transformer constituting each layer may be configured to include four iron core coils as illustrated in FIG. 6. In this configuration, the transformer of each layer can function as a single-phase transformer. FIG. 6 is a cross-sectional view obtained by cutting a single-phase transformer 50A constituting one layer of a single-phase transformer having a multistage structure along a plane parallel to the horizontal direction. The single-phase transformer 50A illustrated in FIG. 6 includes an outer circumferential iron core 40a having an octagonal outer shape in a plan view, and four iron core coils 31a to 34a disposed inside the outer circumferential iron core 40a. The four iron core coils 31a to 34a includes iron cores (leg iron core) 41a to 44a and coils 51a to 54a wound around the iron cores 41a to 44a, respectively. The four iron core coils 31a to 34a have the same shape and size and are disposed at equal intervals in the circumferential direction around a central part P of the outer circumferential iron core 40a and inside the outer circumferential iron core 40a.

By configuring the transformer of each layer to include iron core coils of an even number of four or more as illustrated in FIG. 6, the transformer of each layer can be used as a single-phase transformer. As an example, one single-phase transformer can be configured by a set of iron core coils 32a and 34a in a horizontal direction in FIG. 6, and further one single-phase transformer can be configured by a set of iron core coils 31a and 33a in a vertical direction in FIG. 6.

The multistage structure single-phase transformer of the third embodiment is configured by vertically overlapping the single-phase transformers 50A in two or more stages as in the case of the first embodiment. As in the case of the first embodiment, the coils that overlap vertically are connected in series. Even when the single-phase transformer of each layer has the configuration of FIG. 6, the same effect as that of the multistage structure multiphase transformer 10 illustrated in FIGS. 1A and 1B can be obtained in terms of the ground contact area.

As described above, according to each embodiment, an electromagnetic device capable of suppressing the flux leakage from the coil and reducing the installation area can be realized.

While the present invention has been described with reference to specific embodiments, it will be understood, by those skilled in the art, that various changes or modifications may be made thereto without departing from the scope of the following claims.

In the first embodiment described above, the transformers being stacked vertically in two stages are illustrated, but the number of stages in which the transformers are stacked may be three or more.

The number of the iron core coils disposed in the circumferential direction inside the outer circumferential iron core is not limited to the above-described example. A transformer may be configured to include a various number of three or more of iron core coils inside the outer circumferential iron core. In the first embodiment described above, as illustrated in FIG. 1B, although the tip parts on the side of the central part P of the iron cores 15a to 17a of the iron core coils 15 to 17 are closely contacted to each other, the tip parts of the iron cores 15a to 17a may be configured to connect to each other via a gap.

The iron core constituting the transformer of each layer may not be divided and may have an integral structure. Further, in addition to the method of stacking a plurality of iron sheets, various manufacturing methods known in the art may be used as the manufacturing method of the iron core.

Further, in order to solve the problem of the present disclosure, the following various aspects and the effects can be provided. Note that, the numbers in parentheses in the description of the following aspects correspond to the reference numerals in the drawings of the present disclosure.

For example, the first aspect of the present disclosure is a multistage structure electromagnetic device (10) that includes a plurality of electromagnetic components (11, 21) stacked in multiple stages, wherein each of the plurality of electromagnetic components (11, 21) includes: an outer circumferential iron core (19); at least three leg iron cores (15a to 17a) disposed at intervals in a circumferential direction on an inner surface side of the outer circumferential iron core (19); and coils (15b to 17b) respectively wound around the at least three leg iron cores (15a to 17a), wherein each of the at least three leg iron cores (15a to 17a) is disposed that one end in a direction of a winding axis line of the coil, of the each of the at least three leg iron cores, is magnetically connected to the outer circumferential iron core (19), and the other end in the direction of the winding axis line is magnetically connected to the other end of another leg iron core among the at least three leg iron cores; and the coils (15b to 17b) wound around the at least three leg iron cores of an electromagnetic component (11) in one stage among the plurality of electromagnetic components (11, 21) stacked in the multiple stages and the coils wound around the at least three leg iron cores of the electromagnetic component (21) in another stage among the plurality of electromagnetic components stacked in the multiple stages are respectively connected in series.

According to the first aspect, as the electromagnetic device, the flux leakage from the coil can be suppressed and the installation area can also be reduced.

Further, the second aspect of the present disclosure is the multistage structure electromagnetic device (10) according to the first aspect, wherein the number of the at least three leg iron cores of the electromagnetic component (11) in one stage is the same as the number of the at least three leg iron cores of the electromagnetic component (21) in another stage.

The third aspect of the present disclosure is the multistage structure electromagnetic device (10) according to the first aspect or the second aspect, wherein the plurality of electromagnetic components (11, 21) have the same configuration in terms of the shape and the size of the outer circumferential iron core (19) and the at least three leg iron cores (15a to 17a), and the winding number of the coils (15b to 17b).

The fourth aspect of the present disclosure is the multistage structure electromagnetic device (10) according to any one of the first to third aspects, wherein each of the plurality of electromagnetic components (11, 21) is configured such that the winding axis lines (10) of the coils (15b to 17b) of the at least three leg iron cores are included in a common plane, and the plurality of electromagnetic components (11, 21) are stacked to overlap each other when viewed along a direction perpendicular to the common plane.

The fifth aspect of the present disclosure is the multistage structure electromagnetic device (10) according to any one of the first to fourth aspects, wherein the number of the at least three leg iron cores in each of the plurality of electromagnetic components (11, 21) is a multiple of three.

The sixth aspect of the present disclosure is the multistage structure electromagnetic device according to any one of the first to fourth aspects, wherein the number of the at least three leg iron cores in each of the plurality of electromagnetic components (50A) is an even number of four or more.

The seventh aspect of the present disclosure is the multistage structure electromagnetic device (10) according to any one of the first to sixth aspects, wherein the coil includes at least one of a primary coil and a secondary coil.

The eighth aspect of the present disclosure is the multistage structure electromagnetic device (10) according to any one of the first to seventh aspects, wherein the plurality of electromagnetic components (11, 21) constitute a transformer.

1. A multistage structure electromagnetic device, comprising a plurality of electromagnetic components stacked in multiple stages,
wherein each of the plurality of electromagnetic components includes:
an outer circumferential iron core;
at least three leg iron cores disposed at intervals in a circumferential direction on an inner surface side of the outer circumferential iron core; and
coils respectively wound around the at least three leg iron cores, wherein:
each of the at least three leg iron cores is disposed such that one end in a direction of a winding axis line of the coil, of the each of the at least three leg iron cores, is magnetically connected to the outer circumferential iron core, and the other end in the direction of the winding axis line is magnetically connected to the other end of another leg iron core among the at least three leg iron cores; and
the coils wound around the at least three leg iron cores of an electromagnetic component in one stage among the plurality of electromagnetic components stacked in the multiple stages and the coils wound around the at least three leg iron cores of the electromagnetic component in another stage among the plurality of electromagnetic components stacked in the multiple stages are respectively connected in series.

2. The multistage structure electromagnetic device according to claim 1, wherein
the number of the at least three leg iron cores of the electromagnetic component in one stage is the same as the number of the at least three leg iron cores of the electromagnetic component in another stage.

3. The multistage structure electromagnetic device according to claim 1, wherein
the plurality of the electromagnetic components have the same configuration in terms of a shape and a size of the outer circumferential iron core and the at least three leg iron cores, and the winding number of the coils.

4. The multistage structure electromagnetic device according to claim 1, wherein
each of the plurality of electromagnetic components is configured such that the winding axis lines of the coils of the at least three leg iron cores are included in a common plane,
the plurality of electromagnetic components are stacked to overlap each other when viewed along a direction perpendicular to the common plane.

5. The multistage structure electromagnetic device according to claim 1, wherein
the number of the at least three leg iron cores in each of the plurality of electromagnetic components is a multiple of three.

6. The multistage structure electromagnetic device according to claim 1, wherein
the number of the at least three leg iron cores in each of the plurality of electromagnetic components is an even number of four or more.

7. The multistage structure electromagnetic device according to claim 1, wherein
the coil includes at least one of a primary coil and a secondary coil.

8. The multistage structure electromagnetic device according to claim 1, wherein
the plurality of electromagnetic components constitute a transformer.
